(19) United States
(12) Patent Application Publication
(10) Pub. No.: US 2011/0028008 A1
(43) Pub. Date: Feb. 3, 2011

(54) PROGRAMMABLE STRUCTURE FOR PASSING PARAMETERS TO A CONTROLLER

(75) Inventor: KENT KERNAHAN, CUPERTINO, CA (US)

Correspondence Address: MICHAEL W. CALDWELL, 4226 RIVERMARK PARKWAY, SANTA CLARA, CA, 95054-4150, US

(73) Assignee: ARRAY CONVERTER, INC., SUNNYVALE, CA (US)

(21) Appl. No.: 12/534,156

(22) Filed: Aug. 3, 2009

(51) Int. Cl. H01R 12/00

(52) U.S. Cl. 439/65

(57) ABSTRACT

An enclosure includes a base unit and an insertable unit wherein the base unit has an opening corresponding to the insertable unit. A single structure is formed when the insertable unit is inserted into the base. The base is electrically connected to a first electronic device, such as a solar panel. The insertable unit includes a second electronic device. The base and the insertable unit have connectors that make electrical connections when the insertable unit is inserted into the base unit. The base unit further includes electrical connectors connected to a memory device wherein the electrical connections correspond to matching connections in the insertable unit. Upon assembly the second electronic device reads data prepositioned in the memory device, thereby passing data to the second electronic device. The data may be parametric, characteristic, flag, or a serial number, for example.

### CROSS REFERENCE TO RELATED APPLICATIONS

This application is related to commonly-owned U.S. patent application Ser. No. 12/502,524 submitted Jul. 14, 2009 by Kent Kernahan, which application is incorporated herein in its entirety. This application will be referred to as “the 524 application.”

### BACKGROUND

In the manufacturing of products that are electronically controlled, particularly when the electronic control includes a microcontroller or other logic that can be variously configured, inventories are increased by variations between similar product models wherein the controller is customized for each such variation. In some cases the basic control method of the controller is fixed, with certain parameters being the only difference between two product models. Thus the controller is programmed to include the appropriate parameters for the instant controller product and the two mated during manufacturing. For product held in inventory, the quantity to be held is increased to shorten delivery time after an order is received. For product that is customized as an order is received, delivery time is increased by the time required for customization.

For example, solar panels are tested when they complete manufacturing to determine such parameters as output voltage and current at test conditions. In some systems each panel is mated to a controller, wherein the controller must be programmed to reflect the parameters determined in testing. The controller and panel are electrically connected using a junction box.

The disclosure of the 534 application provides for an electromechanical system somewhat similar to the fashion in which an electric light bulb is connected to its base, power, and on/off switch. According to the 524 application, a base unit is connected securely to the structure of a first electronic device and electrical connections brought into the base unit. The base unit includes one or more threaded surfaces, wherein the threaded surfaces are conductive or include an area that is conductive. A second electronic device to be connected to the first electronic device is manufactured and secured inside an insertable unit that has threads matching those of the base unit. The threads of the insertable unit are also conductive, or include an area that is conductive. The second electronic device is electrically connected to the threads of the insertable unit. Later, such as at the end of a production line or during field installation, the insertable unit is screwed into the base unit, thereby providing the second electronic device with electrical contact with the base unit (thereby to the first electronic device). The base unit and the insertable unit are manufactured such that when the two are screwed together a tight seal is formed. Should the electronics in the insertable unit fail, the insertable unit may be unscrewed and a new unit screwed in. If the first electronic device should fail, the insertable unit can be removed and used with a different first electronic device.

The first electronic device can be any electronic or electrical device, for example a solar panel.

### SUMMARY

For the purpose of illustration, the discussion of the invention will be presented as for a solar panel module, however the concept may be extended to any controlled product that requires customization of a controller. Likewise, the structure according to the 524 application will be used as an illustration of one embodiment of the present invention, though it is clear that the present invention may be practiced with any similar structure wherein a controller within a second substructure is mechanically and electrically connected to a first substructure, the combination thereby forming a complete structure for controlling an apparatus connected with the second substructure. In the context of the present invention, the combination of the two substructures will be referred to as a “junction box.”

According to the present invention, a junction box first substructure is attached and electrically connected with a solar panel during manufacturing, wherein the first substructure includes an electronic memory that is programmed with parameters or customization flags. A controller, configured to be mated to the junction box within a junction box second substructure, is preprogrammed with a control algorithm, but the program does not include all parameters needed by the control program. That is, the program of the controller does not change between a one or more different models except for the definition of certain parameters specific to a given model.

When the controller and junction box are mated, electrical contact is made between the controller and the electronic memory in the first substructure. The controller interrogates the memory device in the first junction box subsystem, thereby to receive the parameters related to the instant solar panel. The controller is then capable of controlling the solar panel in that all parameters needed by the control algorithm are available to the controller.

### BRIEF DESCRIPTION OF THE DRAWINGS

FIG. 1 is a top view and a cross section of a base unit according to the present invention.

FIG. 2 is a top view and a cross section of an insertable unit according to the present invention.

FIG. 3 illustrates how a base unit and an insertable unit would be assembled together.

FIG. 4 shows one example of a memory device embedded in a base unit according to the present invention.

FIG. 5 shows an insertable unit including electronics, wherein the electronics are electrically connected to the memory device shown in FIG. 4.

### DETAILED DESCRIPTION OF THE INVENTION

### Definition of Some Terms

| | |
|---|---|
| EEPROM | Electrically Erasable Programmable Read Only Memory; a |
| | non-volatile memory device which may be electrically erased |
| | and programmed. |
| NVM | Non-volatile memory; a memory device which retains |
| | its data, even when power is removed from it. |
| PCB | Printed Circuit Board |
| IDC | Insulation Displacement Connector. Allows making an |
| | electrical connection by pressing an insulated wire between |
| | two conductive members, which cut through the insulation |
| | to make contact with the wires within. |

The following description is an example of one structure in which the invention may be practiced. It is presented in detail for clarity. However one skilled in the art will know of many different configurations wherein two substructures may be mated.

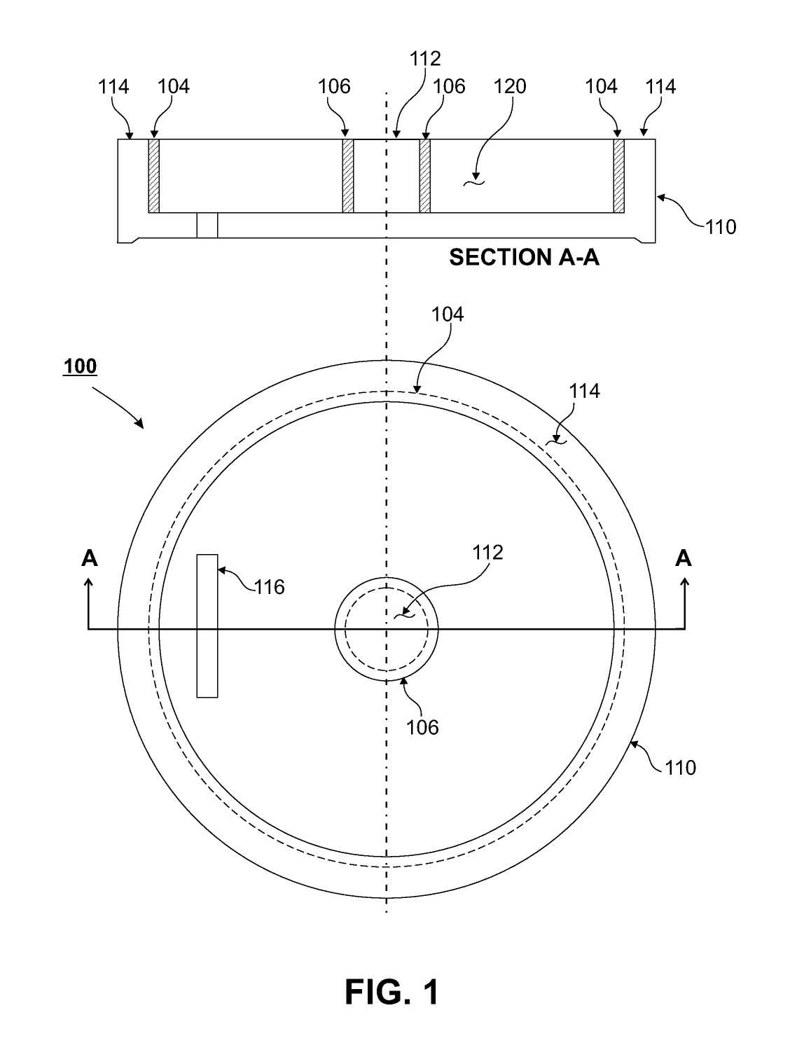

Looking to FIG. 1, a base unit 100 is shown both looking down upon it (that is, looking into the opening end) and in cross section. In this disclosure we may refer to “top” and “bottom” orientations. Such references are only relative to the illustrative figures; the physical units when used according to the present invention may be of any orientation. The base unit comprises a round outer shell 110. In some embodiments a center piece 112 is molded as part of the outer shell 110. The top edge of the outer shell is thick enough to be sturdy such that when the insertable part (discussed later) is screwed into the outer shell 110 the shell 110.114 can withstand the side pressure. In other embodiments a center piece 112 is produced separately from the outer shell 110, then attached to the outer shell 110 by adhesive, a center pin into the floor of the outer shell, or is threaded into a matching threaded hole in the outer shell 110 (not shown). In some embodiments there is no center piece 112.

Around at least part of the inside perimeter of the outer shell 110 are threads 104. The threads 104 may be formed during molding of the outer shell 110 and conductive inserts later placed in the threads 104. In some embodiments the outer shell inside perimeter is smooth, and the threads 104 are a separate, threaded metal piece that fits into the outer shell 110. In similar fashion, the a center piece 112 includes threads 106, wherein the threads 1106 maybe be molded into the center piece material 112 and conductive material added, or the center piece is smooth and the threads 106 are a threaded cylindrical metal piece that slides down over the smooth center piece 112. Other methods will be known to one familiar with the art, wherein a threaded outer and inner (112) part may be constructed such that at least some portion of the threads are electrically conductive.

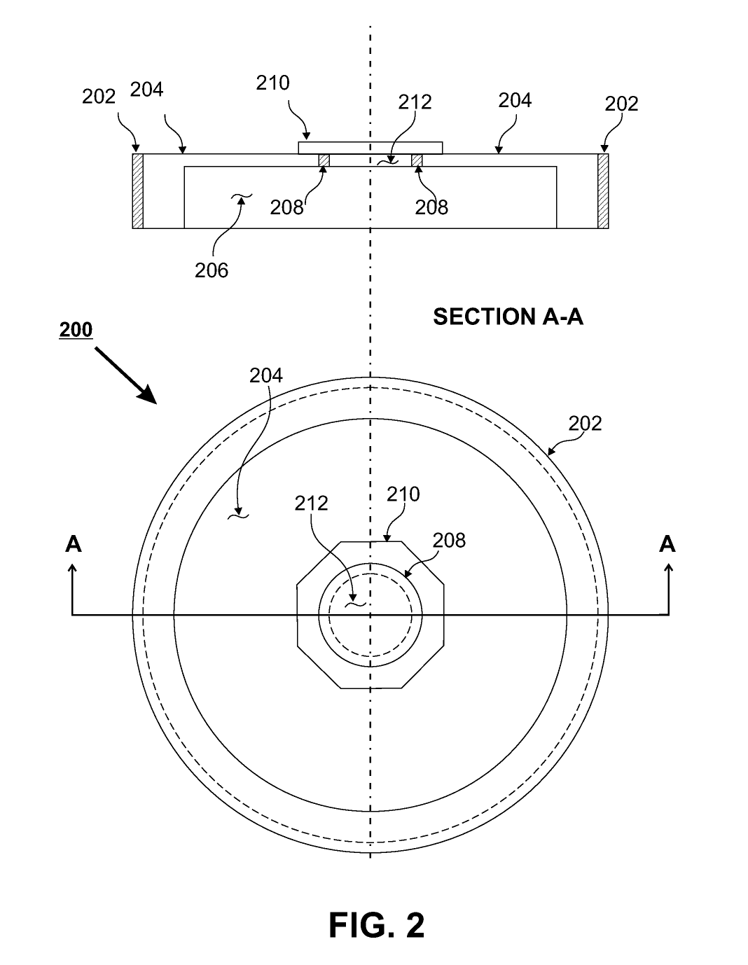

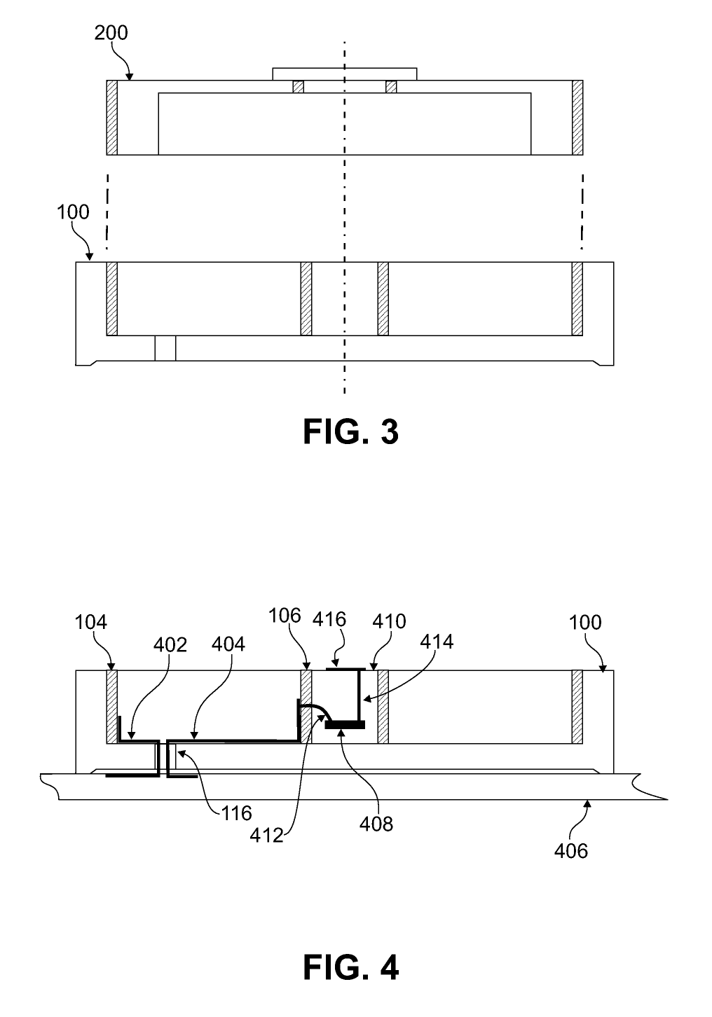

FIG. 2 illustrates an insertable unit 200 according to the present invention. The insertable unit 200 is designed and fabricated such that it can screw into the base unit 100. The height of the base unit 100 and the insertable unit 200 are such that the insertable unit 200 can hold and completely encapsulate an electronic device (not shown in FIG. 2). The insertable unit 200 comprises a body 204, with threads 202 on the outside rim of the body 204. In embodiments of the base unit 100 wherein the base unit includes a threaded center piece 112, the insertable unit 200 includes a hole with threads 208, wherein the treads 208 match the threads 106 of the base unit 100. In some embodiments the insertable unit 200 includes a molded nut shape 210 on the surface, providing means for the insertable unit 200 to be tightened upon installation, or to be removed, using a common wrench. In other embodiments the top surface 204 of the insertable unit 200 has two or more holes molded into it (but not through to the cavity 206) such that a forked tool (not shown) may engage the holes to provide extra torque when installing or removing an insertable unit 200.

In some embodiments the threads 104/202 or 106/208 of the base 100 and the insertable unit 200 are somewhat tapered, similar to pipe threads, wherein the threads will bind and tighten down when the insertable unit 200 is screwed into the base unit 100 a desired amount. In some embodiments the threads 104/202 or 106/208 are like machine threads, having the same diameter along the center axis of the body 100 and insertable unit 200. One skilled in the art will know of other means for forming threads on the two units 100,200 such that they may later be taken apart nondestructively, while providing a tight fit in service.

In some circumstances it may be necessary for the insertable until to have a particular orientation relative to the base unit 100, hence the structure of the first electronic device. This is sometimes accomplished by manufacturing base 100/insertable unit 200 pairs that are a particular orientation when screwed together. In one embodiment the threads 104/106 comprise a plurality of thread sets and the appropriate thread set selected when screwing the insertable unit 200 into the base unit 100 to provide the desired final orientation. For example, in one embodiment there are four sets of threads 104/106 on the base unit 100 provided, each with a thread entry point that is ninety (90) degrees apart from the thread entries on either side. If each thread goes around a whole number of times, for example two, then one may select the final orientation of an insertable unit 200 upon installation by selecting a thread set 104,106 with its opening corresponding to the final orientation.

For example, consider a configuration wherein the conductive threads 104 on the inner surface of the outer ring 110 of the base unit 100 are segmented, rather than a continuous thread around the inner surface, the threads 104 comprising four segments, each electrically isolated from the other, and each with a unique connection to the first electrical device. Now consider that the electrically conductive threads 202 of the insertable unit 200 are similarly segmented. By selecting which set of threads 104 to engage when screwing the two units 100, 200 together one would also select how the two electronic devices are connected. Of course one would be able to vary how many segments, what connections, and such are designed into a given device set to provide for a variety of electrical connection possibilities.

FIG. 4 is an example of one method for electrically connecting the structure of the first electronic device 406 with the conductive threads 104 and 106 of the base 100. In the illustration of FIG. 4, the structure 406 is considered to also be electrically connected to the first electronic device. For example, the structure 406 could be the back side of a solar panel, with electrical leads manufactured into the solar panel on its back side for connection to control electronics in the insertable unit 200. A lead 402 is brought in through an access hole 116 in the base 100 and brought up to the inside surface of the threads 104. Likewise another lead 404 is brought up from the structure 406 and routed to the threads 106 on the outside surface of the center piece 112. In other embodiments the leads 402 or 404 are premade in conjunction with the threads 106 and/or 106 by spot welding or otherwise connecting to the conductive threads. In one embodiment the leads are connected to the controlled product and during attachment of the base 100 to the controlled product 406 the leads 402, 404 are brought up through the access hold 116 and connected to the threads 104, 106 by solder, spot welding, or connectors. So, according to the present invention, the base 100 is preinstalled on the structure of the first electronic device. The insertable unit 200 may be attached at the same time as when the base unit 100 is attached to the controlled product, or the assembly comprising the first electronic device structure and base unit 100 may be shipped or set aside and the insertable unit 200 added at another time.

Continuing with FIG. 4, a non-volatile memory device 408 is embedded in the center post 410. The NVM 408 may be any of a variety of available NVM devices, for example a 20 Kb 1-wire EEPROM, product number DS28EC20, available from Dallas Semiconductor, a division of Maxim Integrated Products, Inc., 120 San Gabriel Drive, Sunnyvale, Calif., 94086. One-wire devices are advantageous in that power and data in/out only require two electrical connections. As has been previously discussed, though, the center post 410 can be configured to provide a plurality of electrical connections, thereby enabling the use of other NVM devices which require more electrical connections.

The NVM 408 has one electrical connection 412 to the outer surface of the center post 410, thereby making electrical connection to the conductor 404, wherein the conductor 404 further connects to the first electronic device (not shown). The conductor 404 may be connected to system ground/return path. In one embodiment, using a one-wire memory device 408, a second conductor 414 is connected to a connector pad 416. In other embodiments the conductor 414 is brought out sideways (relative to the drawing) and connected to conductive tape (not shown) similar to 404, the conductive tape extending up to the top of the post 410, then electrically connected to the connector pad 416.

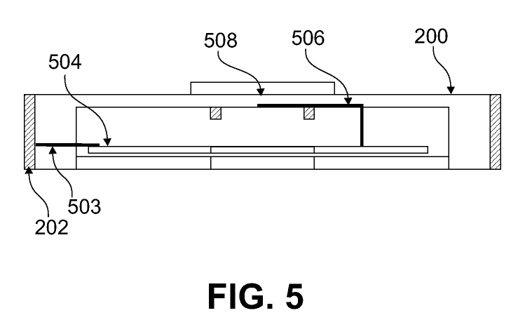

Looking now to FIG. 5, the second electronics 504, including the controller, is embedded in the insertable unit 200. A conductor 506 extends from the top of the insertable unit 200 to the electronics 504, where it is electrically connected to the electronics 504. In one embodiment the electronics 504 are electrically connected to the system ground conductor 404. A variety of routing paths may be used to get the conductor 506 down to the electronics 504, depending upon the details of implementation of the center area 508 of the insertable unit 200. Another lead 503 connects a terminal of the second electronics 504 to the conductive outer threads 202.

The NVM 408 is programmed with data specific to the first set of electronics to which it is connected. For example, for the scenario wherein the base unit 100 is affixed to a solar panel, the NVM 408 is programmed with characteristic data obtained by end of line testing of the solar panel. When the insertable unit 200 is screwed into the base unit 100, the connector 508 makes electrical contact with the matching connector 416, thereby enabling the control electronics 504 to receive data from the NVM 408 by providing the proper control signals to the NVM 408. In some embodiments the control electronics 504 include NVM as well, and once the electronics 504 has received the data from the base unit 100 NVM 408, no further data exchange between the two is necessary. In one embodiment the insertable unit 200 is removed due to failure or other reasons, and a new insertable unit 200 is connected to the base 100, and again the NVM 408 provides the new electronic unit 504 with the stored data.

In some embodiments the electronic unit 504 does not have NVM of its own, and instead receives data from the NVM 408 whenever needed.

In some embodiments the data provided by the NVM is not parametric, but is configuration flags. In other embodiments the data included in the NVM is a serial number, production date, or other static information unique to the first electronics connected to the base 100.

### Resolution of Conflicts

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

1. An apparatus for electrically connecting a first electronic device and a second electronic device, comprising:
a base unit, wherein the base unit is electrically connected with a first electronic device, the base unit comprising:
a structure including an opening for receiving an insertable unit;
a first electrical lead for carrying a signal between a first electrical terminal on the first electronic device and a first electrical connector within the base unit structure, wherein the first electronic device is outside of the base unit structure;
a second electrical lead for carrying a signal between a second electrical terminal on the first electronic device and a second electrical connector within the base unit structure;
an electronic memory device affixed within the base unit, wherein the memory device includes a first electrical terminal and a second electrical terminal;
a third electrical lead for carrying a signal between the first electrical connector and the first electrical terminal of the memory device; and
a fourth electrical lead for carrying the signal between the second electrical terminal of the memory device and a third electrical connector;
an insertable unit comprising:
a structure corresponding to the opening in the base unit such that the insertable unit may be inserted into the base unit, thereby forming one assembled unit;
a second electronic device affixed within the insertable unit, wherein the second electronic device has a first and a second and a third electrical terminal;
a first electrical lead for carrying a signal between the second electronic device first electrical terminal and the base unit first electrical connector after the insertable unit has been inserted into the base unit;
a second electrical lead for carrying a signal between the second electronic device second electrical terminal and the base unit second electrical connector after the insertable unit has been inserted into the base unit; and
a third electrical lead for carrying a signal between the second electronic device third electrical terminal and the first electrical connector on the surface of the insertable unit, thereby electrically connecting the third terminal of the second electronic device with the memory device second electrical terminal.

2. The apparatus of claim 1, wherein the first electrical terminal of the memory device is a ground input terminal and the second electrical terminal of the memory device is a power input and a data input and a data output terminal.

3. The apparatus of claim 1, further including:
a third electrical terminal on the memory device;
a third electrical terminal on the first electronic device; and
a lead for carrying a signal between the third electrical terminal of the first electronic device and the third electrical terminal of the memory device.

4. The apparatus of claim 3, wherein the first electrical terminal of the memory device is a ground input terminal and the second electrical terminal of the memory device is a power input terminal and the third electrical terminal of the memory device is a data input and a data output terminal.

5. The apparatus of claim 1, wherein the memory device has been preprogrammed with data.

6. The apparatus of claim 5, wherein the data is parametric data corresponding to the first electronic device.

7. The apparatus of claim 5, wherein the data is configuration data corresponding to the first electronic device.

8. The apparatus of claim 5, wherein the data includes a one or more flag corresponding to a configuration of the first electronic device.

9. The apparatus of claim 5, wherein the data is a serial number.

10. The apparatus of claim 1 wherein the memory device is a non-volatile memory device.

11. The apparatus of claim 1 wherein the first electronic device is a solar panel.

12. (canceled)

13. (canceled)
